(19) United States
(12) Patent Application Publication
(10) Pub. No.: US 2002/0087451 A1
(43) Pub. Date: Jul. 4, 2002

(54) Security inquiry management techniques

(76) Inventors: David A. Rieger, Warrenville, IL (US); Russell J. Graham, Wheaton, IL (US); Matthew R. Treter, Naperville, IL (US)

Correspondence Address: MCANDREWS HELD & MALLOY, LTD, 500 WEST MADISON STREET, SUITE 3400, CHICAGO, IL, 60661

(21) Appl. No.: 09/752,490

(22) Filed: Dec. 28, 2000

(51) Int. Cl. G06F 17/60

(52) U.S. Cl. 705/37

(57) ABSTRACT

A computer (20) is used to organize security inquiries and potential security purchases. Inquiry information about securities desired for purchase is entered into the computer through an “Enter Inquiries” screen (FIG. 3) and purchase information about available securities is entered into the computer through a window (180) of an “Inquiry Execution” screen (FIG. 5). One of a plurality of algorithms is selected, and the selected algorithm matches the inquiry information with the purchase information. The results are reported on a display (60) of the computer.

### CROSS REFERENCE TO RELATED APPLICATIONS

(Not Applicable)

### STATEMENT REGARDING FEDERALLY SPONSORED RESEARCH & DEVELOPMENT

(Not applicable)

### BACKGROUND OF THE INVENTION

Centralized buyers of fixed income securities, such as trust department buyers and money managers, often are responsible for buying securities to fill dozens of customer inquiries on a daily basis. In some cases inquiries can be grouped together when buying securities, but at other times, restrictions for individual inquiries prevent such grouping. Parameters for inquiries are often specified as a value range rather than specific values further complicating the combination of inquiries. Efficiently managing and filling these inquiries can be very time consuming for securities buyers, and can take valuable time away from their other responsibilities of such securities buyers. Efficient combination of inquiries can also result in better purchase prices for the securities buyers.

As a result, there is a need for techniques, which enable securities buyers to handle fixed income inquiries more efficiently. This invention addresses the need and provides a solution.

### BRIEF SUMMARY OF THE INVENTION

The preferred embodiment is useful for organizing security inquiries and potential security purchases utilizing a computer with a display. In such an environment, inquiry information about securities desired for purchase is entered into the computer, and Potential Purchase information about available securities also is entered into the computer. A plurality of algorithms for matching the inquiry information with the Potential Purchase information also is entered into the computer. A user of the computer then selects one of the algorithms. The selected one algorithm then is used to match the inquiry information with the Potential Purchase information. The results of the matching are reported by means of the computer. Alternatively, a specific inquiry can be selected and securities information stored on a server computer accessed via network Internet connection can be searched for those matching the inquiry criteria.

By using the above techniques, security inquiries may be handled with a degree of efficiency and economy previously unattainable.

### BRIEF DESCRIPTION OF THE DRAWINGS

FIG. 1 is a preferred form of hardware arranged according to the present invention

FIG. 2 is a preferred form of “Main” screen display for the preferred embodiment.

FIG. 3 is a preferred form of screen display generated by initiating the “Enter Inquiries” button shown in FIG. 2.

FIG. 4 is a preferred form of screen display generated by initiating the “Add” button 124 shown in FIG. 3.

FIG. 5 is a preferred form of screen display generated by initiating the “Execute Inquiries” button shown in FIG. 2.

FIG. 6 is a preferred form of screen display generated by initiating the “Search BondWave” menu option when right-clicking on an inquiry in window 140 of FIG. 5.

FIG. 7 is a preferred form of screen display generated by initiating the “View Security Detail” option when right-clicking on a Potential Purchase security in window 180 or 200 of FIG. 5.

FIG. 8 is a preferred form of screen display generated by initiating the “View Message” option when right-clicking on a Potential Purchase security in window 180 or 200 of FIG. 5.

FIG. 9 is a preferred form of the “Final Trade Execution” screen display generated by clicking the “Execute Trades” button 210 in the “Execute Inquiries” window of FIG. 5.

FIG. 10 is a preferred form of the “Order Routing” screen display generated by selecting “Order Routing” from the utilities menu.

FIG. 11 is a preferred form of the “BondWave Offerings” screen display generated by selecting “Offerings” from the utilities menu.

### DETAILED DESCRIPTION OF THE PREFERRED EMBODIMENTS

Security Inquiry Management Techniques in General

In general, a preferred form of security inquiry management techniques made in accordance with the invention stores and organizes inquiries, analyzes the set of inquiries against possible security purchases, efficiently allocates security purchases to individual inquiries, facilitates negotiation of security purchases and provides an array of reports. The securities may be various types of bonds, certain kinds of stocks or the like.

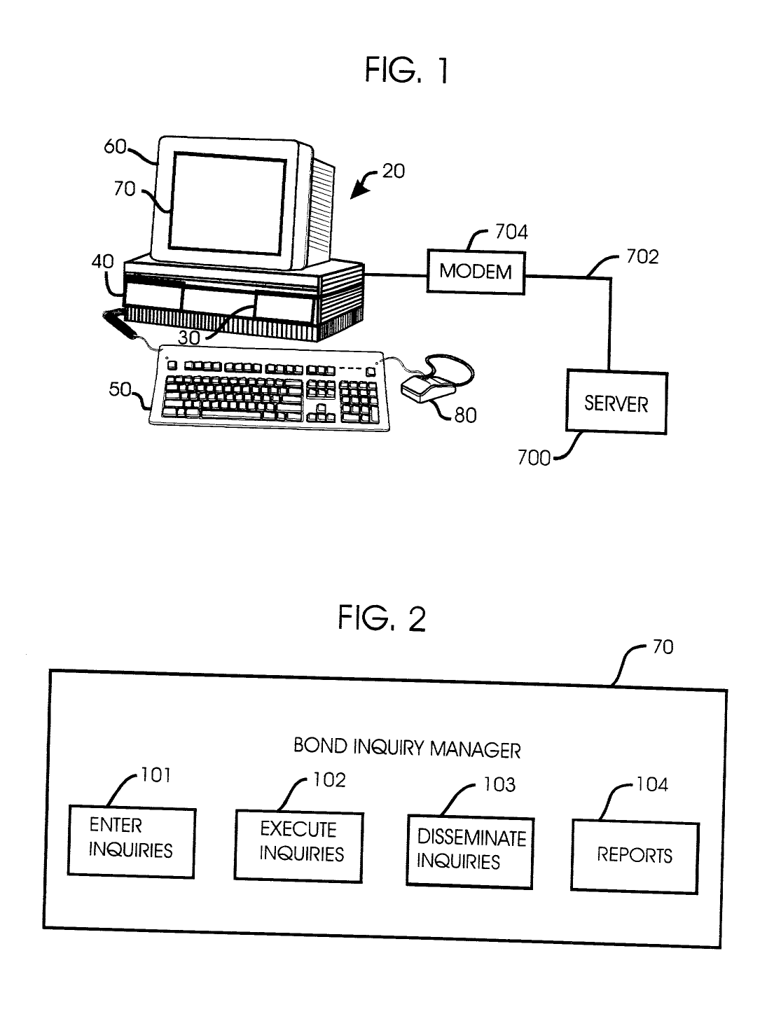

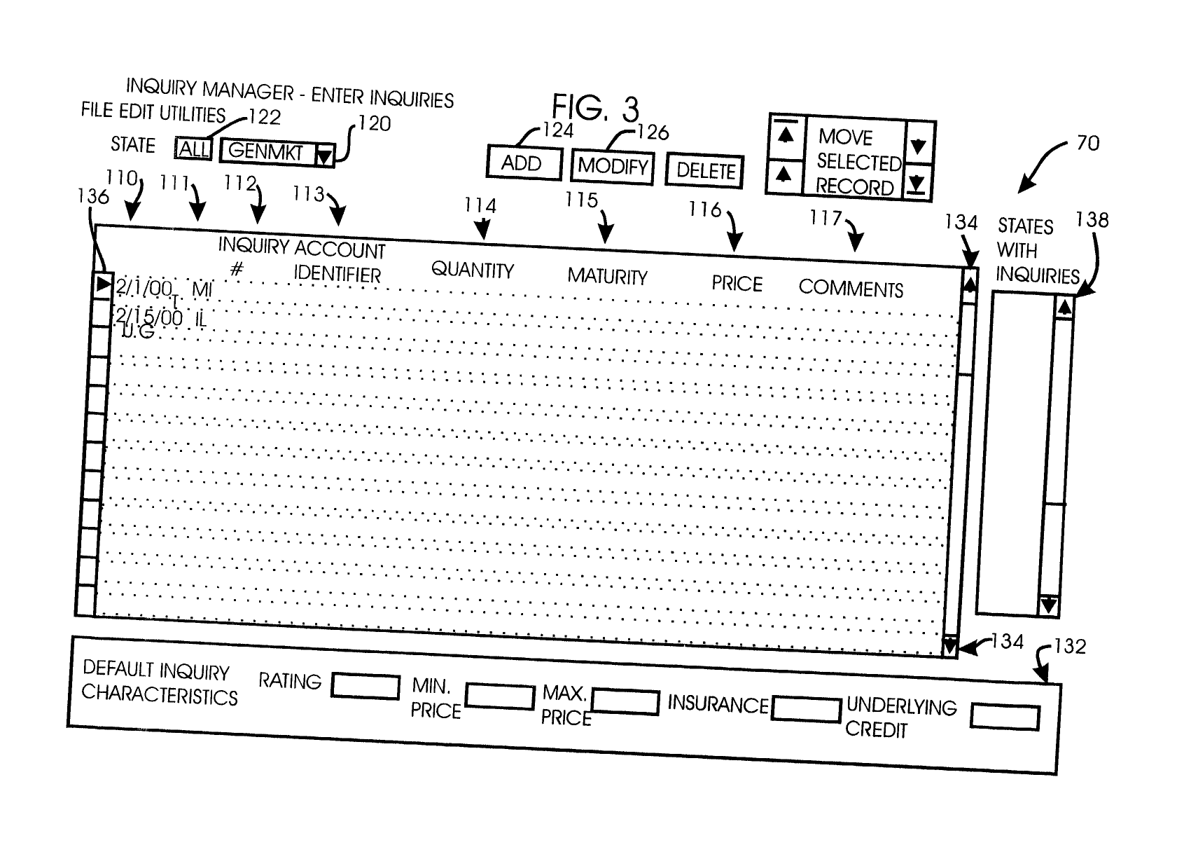

Referring to FIG. 1, the preferred embodiment is implemented on a computer 20 including a central processing unit 30 and a memory 40. Data is entered into the memory by a user via a conventional keyboard 50 or obtained via a network connection to a server computer 700 at a location remote from the location of computer 20. The network connection includes a modem 704, a network 702, such as the Internet, and server computer 700 that stores data in a database. Memory 40 stores instructions that cause data to be processed and to be displayed on a conventional display monitor 60 having a display face 70. The instructions include a plurality of algorithms that enable efficient management of security inquiries. The algorithms may be implemented as a Microsoft Access™ database application. The entry and manipulation of data is enhanced by use of a conventional computer mouse 80. Those skilled in the art are able to program such an application based on this specification and the screen displays illustrated in FIGS. 2-11.

Computer 20 serves as a storehouse for security inquiry information. When the algorithms stored in memory 40 are initiated, they cause a “Main” display to be displayed on an output device, such as display face 70 as shown in FIG. 2. Alternatively, a printer could display information. The “Main” display includes an “Enter Inquires” button 101, an “Execute Inquiries” button 102, a “Disseminate Inquiries” button 103 and a “Reports” button 104.

When button “Enter Inquires” 101 is initiated, the algorithms create a display of the type shown in FIG. 3 on display face 70. The FIG. 3 display enables security inquiry information to be viewed, added, deleted or modified. Once the security inquiry information is added, it is available for dissemination, analysis and trade execution.

Referring again to FIG. 2, after sorting and aggregating various security inquiry information, the algorithm allows dissemination of all or part of this security inquiry information to interested parties, such as security dealer coverage, by initiating or clicking on button 103 with mouse 80. The algorithms available to be invoked after initiating or clicking on button 103 enable the dealer coverage to obtain up-to-the-minute security inquiry information, either electronically, or through reports designed for faxing.

Once a security inquiry is filled by a trade execution, the historical information about the security inquiry and trade execution is stored within memory 40.

Referring again to FIG. 3, security inquiries are defined by the following parameters or information: date of inquiry (e.g., 2/1/00) and inquiry type designations (e.g., “U”, “T”, and “G” for “unique maturity year”, “total par”, and “grouped” inquiry types respectively) in column 110, state (e.g., MI or IL) in column 111, inquiry number (#) in column 112, account identifier in column 113, quantity, such as inquiry block sizes description (e.g., 2×100/50 indicating one inquiry line for two blocks of 100 and a second inquiry line for one block of 50) in column 114, maturity year ranges description (e.g., 02-04,07/10 indicating one inquiry line with required maturity in 2002, 2003, 2004 or 2007 and a second inquiry line with required maturity in 2010) in column 114, price information, such as block size in thousands of dollars of par (e.g., 100 for $100,000) or price restriction (e.g. must be priced between 98 and 102) in column 116 and special comments, such as security characteristics restrictions in column 117.

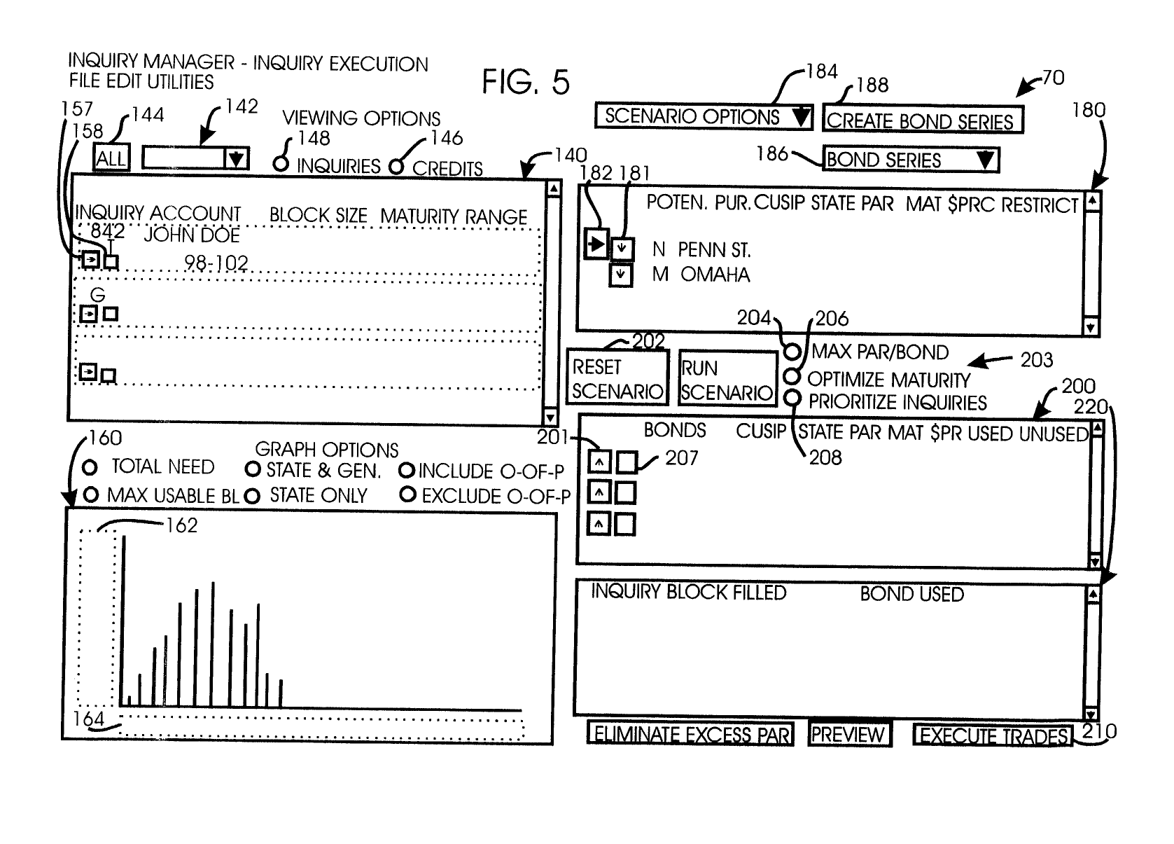

Referring to FIG. 5, security inquiries that remain open (i.e., which have not been fully satisfied through the purchase of securities) are viewed in list form or graphical form. The list form is displayed in a window 140 of display face 70, and the graphical form is displayed in a window 160 of display face 70. Users have the option of viewing the inquiry graphical form in several different ways. Users also are able to enter real or hypothetical purchase information about securities available for trading in a window 180 of display face 70.

Referring again to FIG. 5, inquiries displayed in window 140 are defined by the following information: inquiry number (e.g., 842), account name (e.g., John Doe), inquiry block sizes description (e.g., 2×100/50 indicating one inquiry line for two blocks of 100 and a second inquiry line for one block of 50), maturity year ranges description (e.g., 02-04,07/10 indicating one inquiry line with required maturity in 2002, 2003, 2004 or 2007 and a second inquiry line with required maturity in 2010), inquiry type designations (e.g., “U”, “T”, and “G” for “unique maturity year”, “total par”, and “grouped” inquiry types respectively), account number (e.g., 1234) (not shown in FIG. 5), “Out of Play” designation check box 158 (e.g., 158 checked indicates inquiry is “out of play”), price restriction (e.g. 98-102 indicates that securities used to fill inquiry must have dollar prices between 98 and 102), comment area (e.g., securities must be insured) (not shown in FIG. 5) and state (e.g., IL) (not shown in FIG. 5). The information in window 140 not shown in FIG. 5 may be viewed by using mouse 80 to click on an arrow (not shown) that brings the information into window 140.

Referring again to FIG. 5, Potential Purchase information entered and displayed in window 180 in vertical columns under the illustrated column headings as defined by the following information: security description (“POTEN. PUR.”)(e.g., Penn St Univ Rev), CUSIP (an industry standard identification code which is unique for each security), STATE (e.g., IL), par amount (“PAR”) in thousands of dollars (e.g., 500 for $500,000), maturity date (“MAT”) (e.g., 7/1/05), dollar price (“$PRC”) (e.g., $99.50) and restriction (“RESTRICT”) (e.g., use to fill state specific inquiries first).

The available Potential Purchase security information displayed in window 180 is analyzed or matched against the open security inquiry information displayed in window 140 by three different algorithms “Maximize”, “Optimize” and “Prioritize” as selected from the “Scenario Options” menu 184, which displays option scenarios 203 (FIG. 5). The method of analysis is selected by selecting one of the three different algorithms indicated by buttons 204, 206 and 208. Once the analysis method is selected, clicking the “Execute Inquiries” button 102 (FIG. 2) causes the computer to execute the corresponding algorithm and display a resulting potential purchase scenario in windows 200 and 220 (FIG. 5) of display face 70.

Referring again to FIG. 5, active scenario securities displayed in window 200 are defined by the following information: security description (“BONDS”) (e.g., Penn St Univ Rev), CUSIP (an industry standard identification code which is unique for each security), STATE (e.g., IL), total par amount of the security available (“PAR”) in thousands of dollars (e.g., 500 for $500,000), maturity date (“MAT”) (e.g., 7/1/05), dollar price (“$PRC”) (e.g., $99.50), par amount of the security used to satisfy inquiries in the scenario (“USED”) in thousands of dollars (e.g., 100 for $100,000), “extra” or unused par amount of the security (“UNUSED”) in thousands of dollars (e.g., 400 for $400,000) and the “Frozen status” designation in check box 207 (e.g., 207 checked indicates active scenario security and its currently matched inquiry lines, if any, are “frozen”).

If the analysis produces a desired scenario, the user can “freeze” the results through check box 207 until the securities are purchased. During the time that a scenario is “frozen”, the associated inquiry security blocks are kept out of the open inquiry lists so that running another scenario cannot fill them. Once the purchase of a Potential Purchase security has been confirmed, a scenario can be executed, and the user will be prompted for trade details. At this point, the algorithms will store the trade information in a database in memory 40 (FIG. 1), and take all the associated inquiry security blocks out of the open inquiry lists. A report can be generated that will list applicable information needed for producing trade tickets for the user's internal systems.

The algorithms provide many reporting options. Reports exist for both open inquiries and executed security trades. Options also exist to mask private/confidential account information so that the report can be faxed or the private/confidential account information may be unmasked and included for “in-house” reporting.

Inquiry Entry

Referring the FIGS. 1 and 2, the inquiry entry screen is generated by clicking on the “Enter Inquiries” button 101 with mouse 80. An exemplary inquiry entry screen is shown in FIG. 3. The FIG. 3 screen is used to enter, modify and delete inquiry information about securities desired for purchase by the user. Each line of inquiry entered in FIG. 3 typically is limited to a single issuer name. A “State” pull-down-menu 120 controls which security inquiries are viewed, and what state a new inquiry will represent. The “State” menu includes a “general market” (GM) choice, which is used to designate non-state-specific security inquiries. An “All” button 122 shows inquiries for all states. The security inquiry information can contain an unlimited number of lines. Only a few lines are shown as dotted line boxes in FIG. 3 to illustrate the principle.

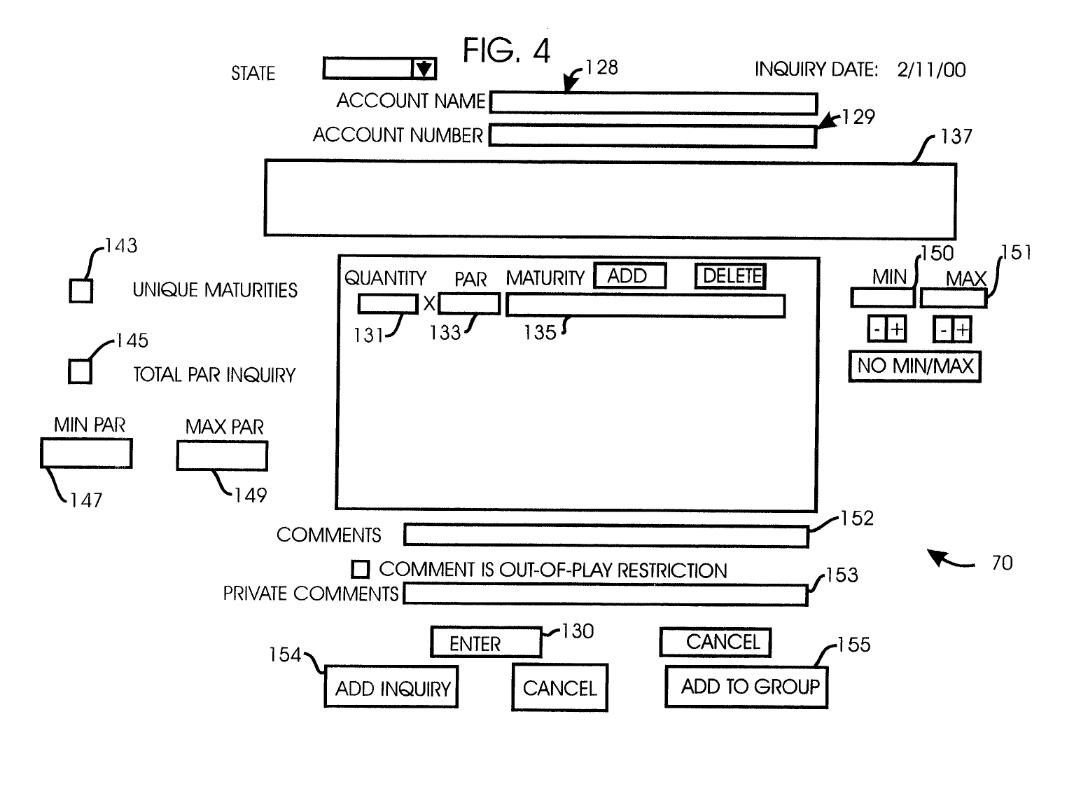

Still referring to FIG. 3, when “Add” button 124 or “Modify” button 126 is clicked by mouse 80 (FIG. 1), an “Inquiry Entry” pop-up window appears as shown in FIG. 4. All entries in the FIG. 4 pop-up represent information regarding a single inquiry, for which no two blocks of securities may (typically) have the same associated issuer. Separate inquiries are entered in separate “Inquiry Entry” pop-up windows.

Referring to FIG. 4, in the fields 131, the quantity of blocks of securities desired is entered for each inquiry line. In the fields 133, the par value of the securities per block in thousands of dollars is entered for each inquiry line. The desired maturity time range (i.e., a range of security maturity years) is entered through the buttons in an area 137 for the current inquiry line. Fields 135 indicate the resulting maturity time range description for each inquiry line. In principle, an inquiry can contain an unlimited number of inquiry lines.

In the “Inquiry Entry” pop-up window of FIG. 4, an account name field 128 and an account number field 129 represent the customer account designation for the inquiry. Text describing inquiry comments or special restrictions can be entered in comments text box 152 if an inquiry has requirements that fall outside of the typical inquiry characteristics that are entered in a “Client Profile” area (not shown). These typical inquiry characteristics are displayed in an area 132 shown at the bottom of FIG. 3. Text describing other information concerning the inquiry that are private/confidential in nature, i.e., not to be communicated to the sellers of securities, can be entered in the private comments text box 153 (FIG. 4).

Referring again to the pop-up window of FIG. 4, text boxes 150 and 151 allow entry of minimum and maximum dollar prices respectively which are acceptable for all blocks of the inquiry. “Unique Maturities” check box 143 designates that the inquiry is a “Unique Maturity” type inquiry. This designation causes the maturity range for an inquiry line to be updated automatically on purchase execution of a corresponding security, removing the maturity year of the purchased block from the inquiry line's maturity range. For example, if an inquiry line specified 3 blocks with maturities 2011, 2012, 2013 or 2014 and a purchase of a block with maturity 2012 is made for that inquiry line, the inquiry line is updated to indicate that 2 blocks with maturities 2011, 2013 or 2014 are left. “Total Par Inquiry” check box 145 designates that that the inquiry is “Total Par” type inquiry and causes the “Min Par” 147 and “Max Par” 149 text boxes to be displayed. This designation allows an inquiry line's total quantity requirement to be satisfied with blocks of various sizes, provided that they satisfy the minimum and maximum size restrictions denoted by 147 and 149. “Unique Maturity” and “Total Par” type inquiries are not mutually exclusive.

Referring again to the pop-up window of FIG. 4, after all inquiry information has been entered, a unique inquiry number is assigned to the inquiry after the “Add Inquiry” button 154 or “Add to Group” button 155 is clicked by mouse 80. The “Add Inquiry” button returns the user to the Inquiry Entry screen of FIG. 3. The “Add to Group” button causes the inquiry to be saved and the pop-up window of FIG. 4 to be redisplayed with all data entry fields re-initialized. The new inquiry entered will be grouped together with the previously entered inquiry. Grouping inquiries together prevents automated matching of Potential Purchase securities to any of the grouped inquiries (when running scenarios) unless at least one block for each inquiry in the group can be filled. There is no limit to the number of inquiries that can be grouped together.

Referring again to FIG. 3, the order in which the inquiries appear in the displayed list reflect the order in which they are considered for being filled in a Prioritized “What-if Scenario”. In a Prioritized “What-if Scenario”, inquiries are filled from top to bottom as displayed on display face 70 with individual inquiry lines filled from first to last. Up/down arrows 134 are used to modify the order in which the inquiries appear in the list of inquiries. An inquiry is moved in the list by clicking on a record selector 136 to the left of an inquiry to select it, and then clicking on one of the up/down arrows 134.

Still referring to FIG. 3, a control 138 shows the user all states for which an open inquiry exists. Clicking on one of these states causes all inquiries for that state to be displayed.

Inquiry Execution

The screen display shown in FIG. 5 is entered by clicking on the “Execute Inquiries” button 102 (FIG. 2). A state selector 142 controls the inquiries displayed for the user in the inquiry information list window 140. Only states with current inquiries appear in the selection list in the state selector 142. An “All” button 144 shows all inquiries for all states.

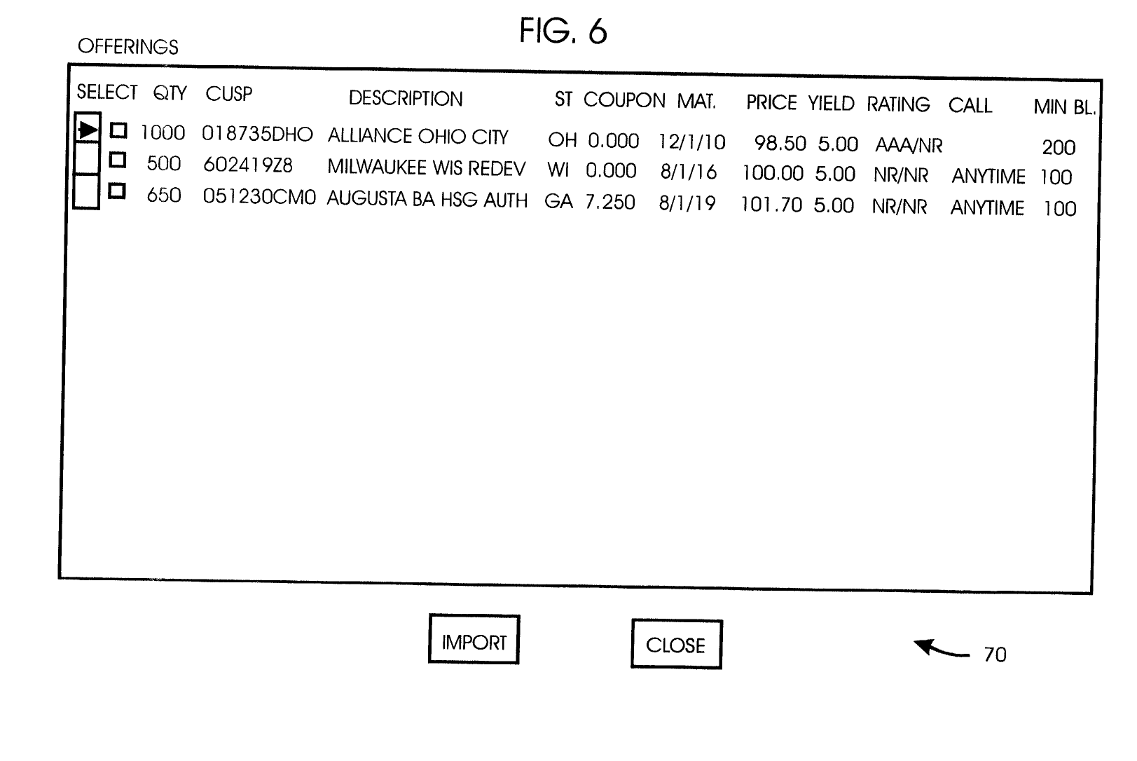

By clicking on a “Credits” button 146, window 140 displays the credits (i.e., approved security issuers) approved for the state that is being viewed. By clicking an “Inquiries” button 148, all of the inquiries for the selected state will be in view in window 140. Inquiries that have special restrictions will default to “Out of Play” with their corresponding “Out of Play” check boxes 158 checked. If an “Out of Play” special restrictions inquiry is set to “In Play” for a scenario (by clearing its corresponding “Out of Play” check box 158), it will be taken back out of play after the scenario is run. An inquiry that has no special restrictions will be in play until checked “Out of Play”, and will return to its default value of “In Play” after the scenario is run. Double-clicking on an inquiry in window 140 will display previous execution and current scenario information for the inquiry. Right-clicking on an inquiry in window 140 displays five options: “Modify Selected Inquiry”, which takes the user directly to the pop-up window of FIG. 4, allowing the inquiry to be modified; “Search BondWave”, which, through network connection 702 to the Internet, will display and report (in the pop-up window of FIG. 6) corresponding descriptions of securities stored on the server 700 which satisfy the current inquiry's parameters; “View Inquiry Activity”, which will display previous execution and current scenario information for the inquiry; “View Portfolio”, which, if portfolio related data is stored in the prescribed manner in a data file in memory 40, will display portfolio contents information for the account associated with the selected inquiry; and “View Group”, which will display information about other open inquiries that have been grouped with the current inquiry. “Manual mode” arrow buttons 157 allow inquiries to be explicitly applied to the currently selected security in the scenario results area 200. This allows matching of inquiries with securities regardless of inquiry parameters.

Graphical window 160 shows the total par or “maximum usable block size” that is represented by current inquiries for each maturity year. (The “maximum usable block size”, typically less than the total par amount, reflects that multiple block inquiry lines can have at most one block filled from a specific security offering. For example, an inquiry line for 3 blocks of 100 represents a total par amount of 300 and a maximum usable block of 100 for a specific security.) The user can view the graph for inquiries specific to the state selected by 142 alone, or can view the state inquiries combined with “general market” (GM) inquiries. Options exist to add or remove the “Out Of Play” inquiries from the graph. The graph can be hidden through a “Hide Graph” button (not shown) to provide more area for viewing inquiry information. Dollar amounts (in thousands) of security par amounts are displayed in area 162 on the Y-axis of the graph and maturity years are displayed in area 164 on the X-axis of the graph.

A Potential Purchases window 180 of FIG. 5 is used to enter characteristics of securities or information about available securities to be run in a “What If Scenario.” The information entered includes an identification of the issuer (Potential Purchases, “POTEN. PUR.”), CUSIP number, STATE of security issuance (e.g., IL), par value (“PAR”), maturity date (“MAT”), dollar price (“$ PRC”) and restrictions (“RESTRICT”), if any. Each Potential Purchase has the option of being applied to only state specific inquiries, “general market” inquiries, both or neither. This choice is made by selecting from the restriction pull-down list (not shown) for each Potential Purchase. Each Potential Purchase also has a text area just beneath it (not shown) where comments can be entered. By default, this comments text area is hidden from view. If there are any messages (from offerers) associated with a Potential Purchase, it is indicated just to the left of the offering either by a green “N” indicating that there is a new message or by a red “M” indicating that there is at least one message associated with the security, but no messages that have not been read.

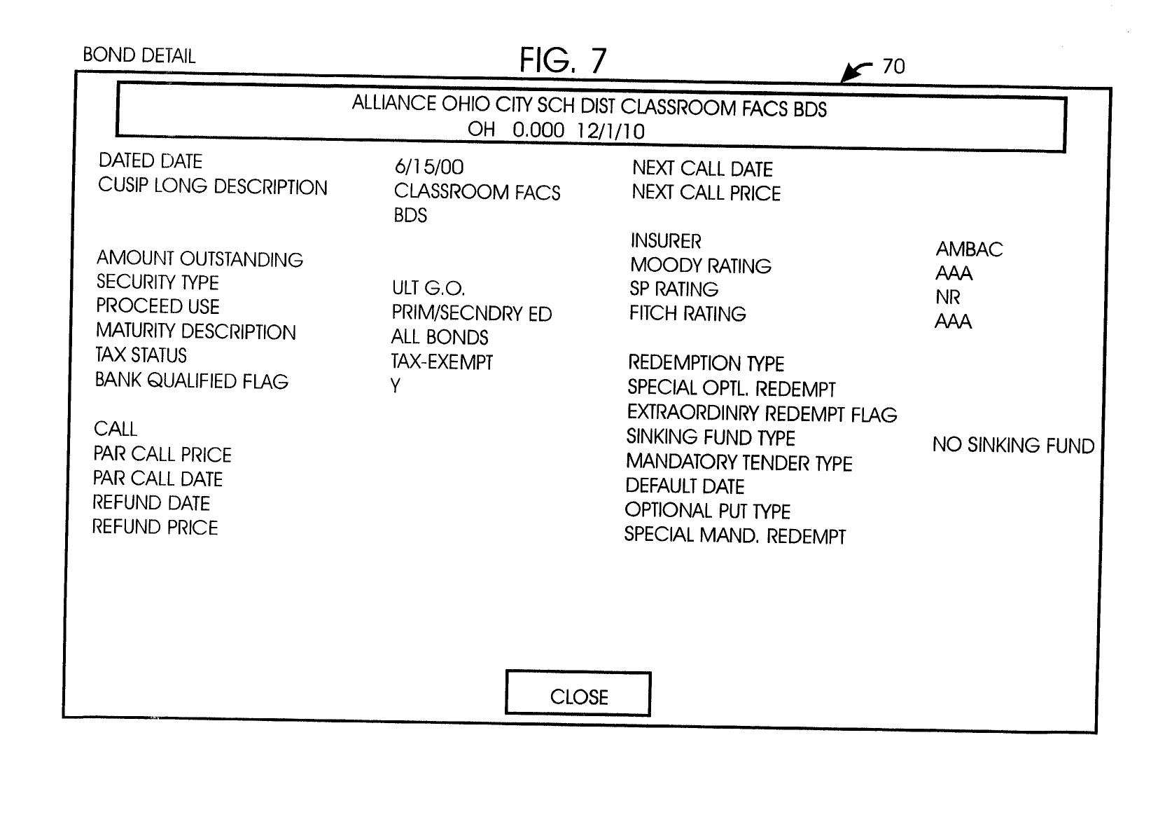

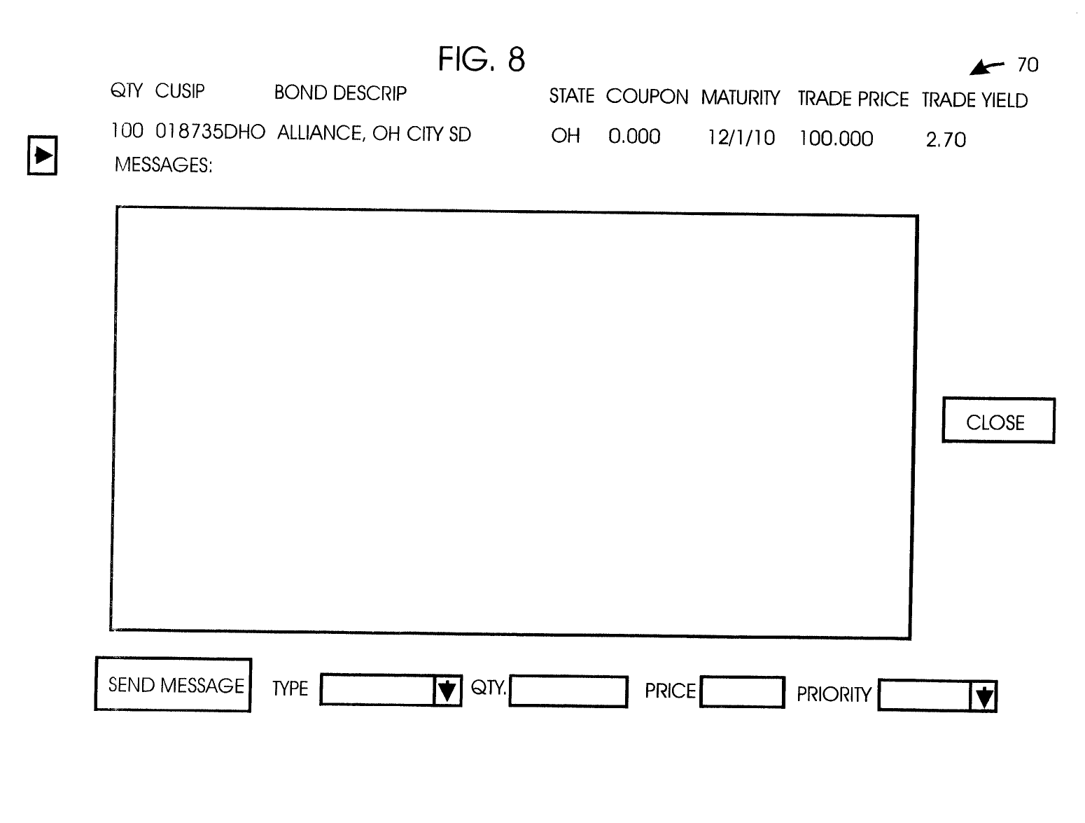

Still referring to the Potential Purchases window 180, right-clicking on a Potential Purchase security displays four options: “Minimize Security View/Expand Security View”, which either displays or hides the security comments area for all Potential Purchase securities in both window 180 and 200. (“Minimize Security View” is shown if the comments area is currently expanded and “Expand Security View” is shown if the comments area is currently minimized.); “View Security Detail”, which, through network connection via the Internet to server 700, will display and report in the pop-up window of FIG. 7 detailed information about the security; “View Message”, which will display and report in the pop-up window of FIG. 8 message information for the selected security obtained through network connection via the Internet to server 700; and “Delete Selected Security”, which, after prompting for confirmation, will remove the selected security from the display area. Manual Mode arrow buttons 181 allow Potential Purchases to be explicitly added to a scenario.

A “Create Bond Series” button 188 allows simplified entry of new issuance scales (for municipal bonds) based on the selected item from the list in window 180. A “Bond Series” menu 186 allows selection of either “Increase Maturity” or “Decrease Maturity”. A setting of “Increase Maturity” causes “Create Bond Series” button 188 to add an additional security to be added to window 180 that has the same characteristics as the currently selected security except for the maturity, which is one year later than. Likewise, a setting of “Decrease Maturity” adds a security with a maturity one year earlier.

The scenario results from executing one of algorithms from the “What-If Scenarios” 203 are presented in windows 200 and 220. Window 200 lists the Potential Purchase securities of window 180 that have been run in a scenario against the inquiry securities of window 140. Window 220 lists the inquiry blocks that were filled in the scenario. With respect to running a scenario, if the “Potential Purchase” is given a CUSIP, the issuer will be checked against any previous scenarios or executions that have involved other blocks from the inquiry. If a similar or matching issuer is found, the user will be warned and given the option to either use or not use the block in the scenario. A scenario can be reset by pressing a “Reset” button 202. Inquiry blocks are always filled as “All or None” (i.e., they are never partially filled).

The Active Scenario Securities window 200 includes, in addition to the fields displayed in window 180, the amounts of the securities (in thousands of dollars of par amount) that are used by scenarios (“USED”) and how much is left over (“UNUSED”). Right-clicking on an Active Scenario security displays five options: “Minimize Security View/Expand Security View”, “View Security Detail” and “View Message”, will function the same way as they do in window 180 as described above; “Save Excess Par As New Security” will split the security amount into two parts, leaving only the amount in the Active Scenario Securities window 200 that are used by inquiries in the current scenario, and placing the remaining amount (as indicated in the “UNUSED” field) back in the Potential Purchase window 180; and “Eliminate Excess Par”, which reduces the quantity of securities in the Active Scenario Securities window 200 to match the amount that are used by inquiries in the scenario.

Automatic matching of inquiries with securities via “What-If Scenarios” can be performed in one of three modes:

The “Maximize Par Per Security” mode 204 (set by selecting “Maximize” from the “Scenario Options” menu 203) executes an algorithm that matches up for each dollar amount of Potential Purchase security, in sequence or in turn, as much par dollar amount of inquiry securities as possible, regardless of the order of the inquiry securities.

The “Optimize Maturities” mode 206 (set by selecting “Optimize” from the “Scenario Options” menu 203) executes an algorithm that matches up Potential Purchase securities with inquiry securities based in an attempt to use the greatest total amount of securities, regardless of security and inquiry sequence. In addition, the algorithm attempts to match up the maturity range of the inquiry securities with the maturity date of the Potential Purchase securities. According to one variation, the algorithm attempts to match inquiry information with a smaller range of maturity times before attempting to match inquiry information with a larger range of maturity times. The “Prioritize Inquiries” mode 208 (set by selecting “Prioritize” from the “Scenario Options” menu 203) executes an algorithm that matches up Potential Purchase securities in sequence with inquiry securities on a first-in, first-out basis based on the order of the inquiry securities in window 140. For example, the order in window 140 can be the order in which inquiry security information is entered into computer 20.

Manual mode arrow buttons 201 allow Potential Purchases and their associated inquiries to be removed from a scenario. “Deep freeze” check boxes 207 allow the Potential Purchase and currently matched inquiries to be frozen such that they are not affected by the “Reset” button 202 or the “Execute” button 210. The “frozen” Potential Purchase securities and the associated inquiry blocks displayed in window 220 can be set back to their normal “unfrozen” state by clicking check box 207 again so as to remove the check mark.

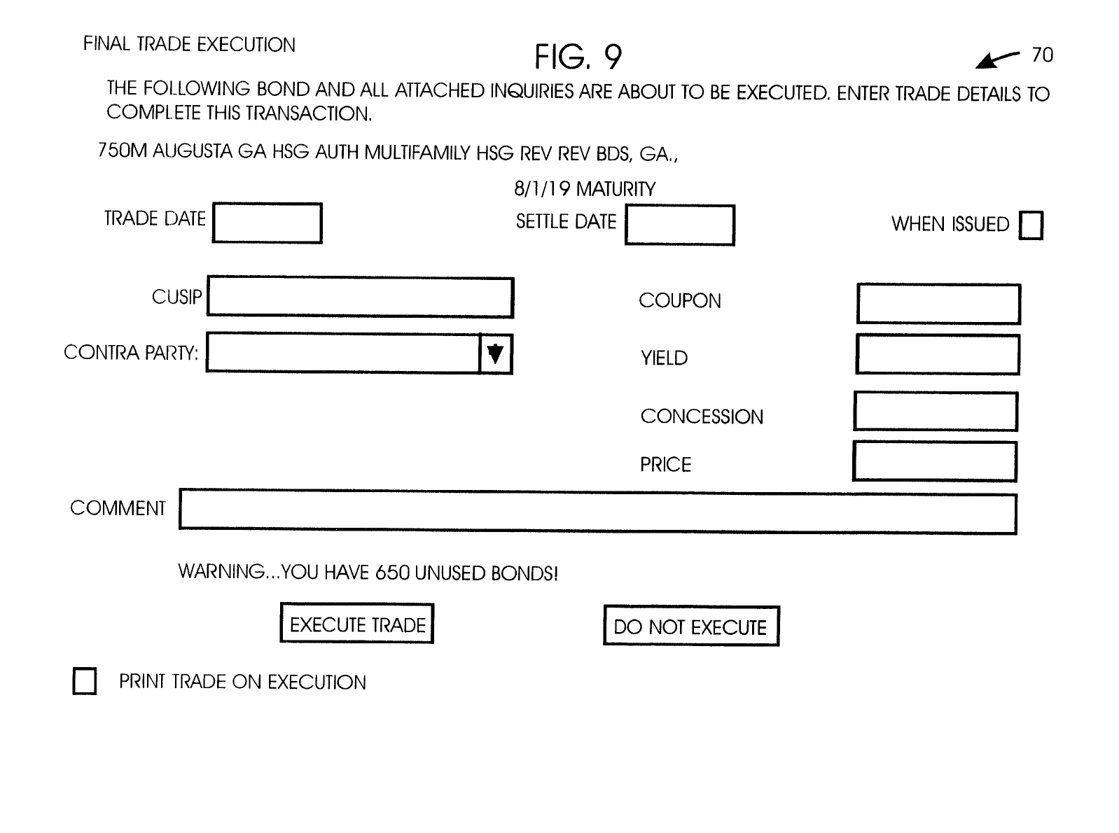

Scenario results for all Active Scenario securities (other than those that are currently frozen) can be permanently applied to the inquiry database stored in memory 40 by clicking the “Execute” button 210. For each Active Scenario security in sequence, the “Final Trade Execution” pop-up window of FIG. 9 is displayed and the user is prompted to enter a CUSIP (if one was not entered in the Potential Purchase window 180), a broker/dealer and other fields to finalize the trade. A final check for similar or matching issuers for previous security purchases for an inquiry will be performed before the trade is executed or finalized. The trade is executed by clicking on the “EXECUTE TRADE” button. Current inquiries are updated to reflect the execution activity.

Reporting

Several reports are available through display on display face 70 or through a printer (not shown):

Executed trade reports generate a list of all purchases for an entered date range that the user has executed, including a list of all inquiry blocks that were filled with the purchase. Securities will be listed in order of trade date. When the report is run, the user is prompted for beginning and ending dates. All trades that have been executed or finalized between the begin date and the end date will appear on the report. Variations of executed trade reports show historical trade activity by state or dealer.

Inquiry reports generate the current list of open (unfinalized) inquiries (i.e., those inquiries not finalized or executed). Report options control whether inquiry reports show which blocks of an inquiry have been filled with what securities, show only inquiries from a specified date range or contain graphical output that show the amount of securities needed by maturity and state. Approved credits reports include users' designations of approved or disapproved credits. Grouping and sorting options are provided for these reports.

Utilities

Twelve utility functions are provided on the “Utilities” menu, which is available from all the screens in the application:

“Backup Inquiry Manager”—A backup database utility creates a copy of the Inquiry Manager database in the folder specified in the “System Settings” utility area, either on computer 20 or a network folder location accessible from computer 20. This copy serves as a backup if the working database becomes corrupted.

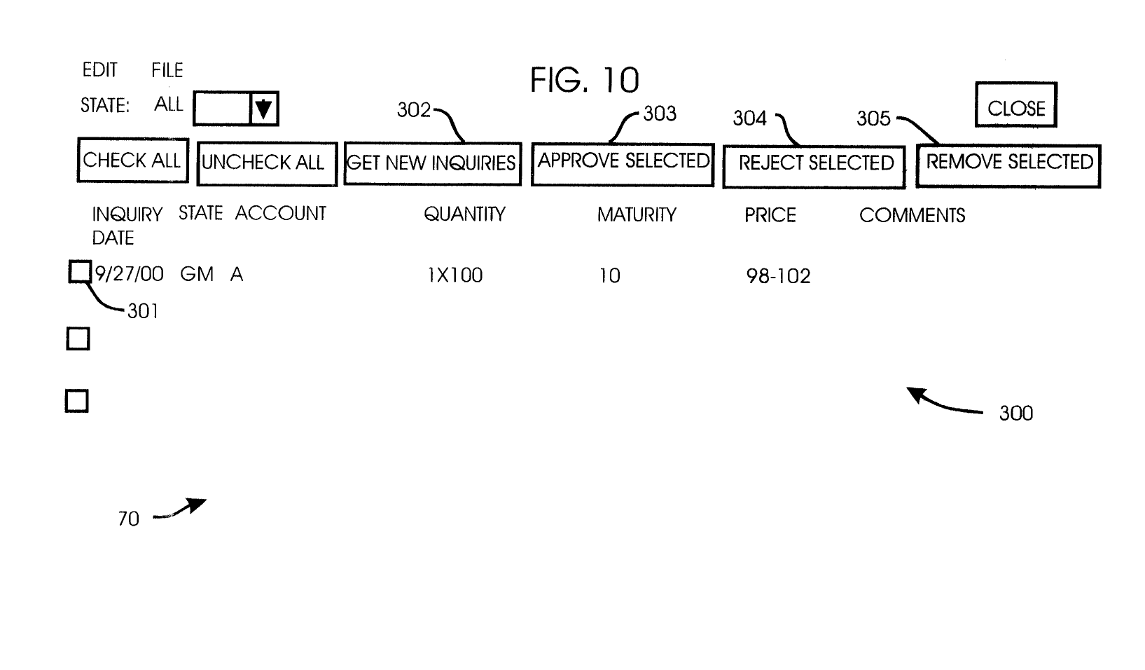

“Order Routing”—Selection of this menu item creates a display of the type shown in FIG. 10 on display face 70. This screen shows and reports inquiries in display area 300 that have been independently sent in from portfolio managers or the like to server 700 via network connection 702 to the Internet. The Inquiry Manager user, through a network connection to server 700 can import these inquiries to memory 40 of computer 20 by clicking “Get New Inquiries” 302. The user can then designate which of these inquiries he wishes to work with by clicking checkboxes 301. Selected inquiries are added to his active inquiries in his Inquiry Manager database by clicking “Approve Selected” 303. Selected inquiries are rejected by clicking “Reject Selected” 304 or action can be postponed by clicking “Remove Selected” 305.

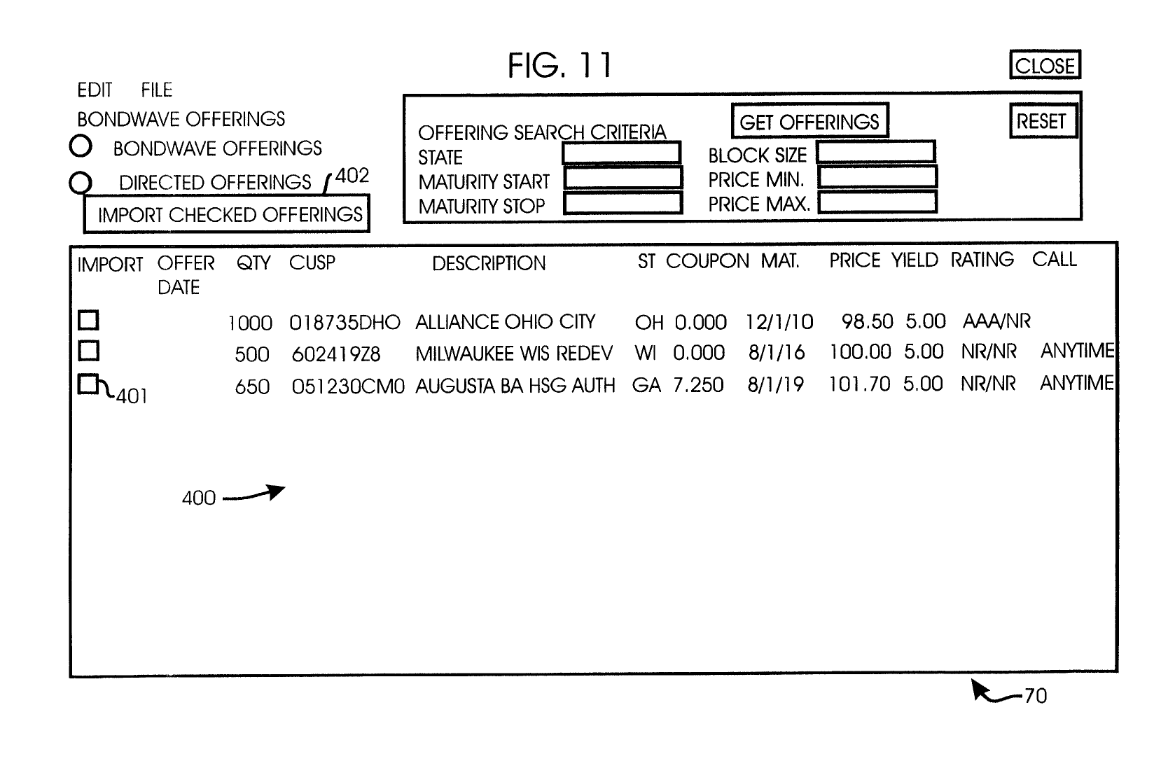

“Offerings”—Selection of this menu item creates a display of the type shown in FIG. 11 on display face 70. This screen shows and reports offerings in display area 400. The security offerings displayed have been posted by security offerers that have sent them to server 700 via network connection to the Internet 702. The Inquiry Manager user, through a network connection to server 700 via the Internet can search these offerings based on various security parameters. Offerings can be brought into the Potential Purchase area of the Inquiry Execution window of FIG. 5 by selecting them with check boxes 401 and clicking on “Import Checked Offerings” 402.

“Messages”—Selection of this menu item creates a display (not shown) that allows the user to view incoming messages and send outgoing messages in order to allow negotiation of securities trades.

“New Issuance”—Selection of this menu item creates a display (not shown) that shows new issuance offerings (as opposed to secondary offerings) in a display area in a manner that is similar to the “Offerings” utility described above.

“Portfolios”—Selection of the “Portfolios” utilities menu item creates a display (not shown) that indicates all current security holdings information. This menu option is not available unless portfolio related data is stored in the prescribed manner in a data file in memory 40 of computer 20.

“My Preferences”—A client profile utility provides user customization options that control the behavior of the application. The preferences are broken up into five sections: “General”, which includes user information such as name and phone, typical inquiry characteristics and Inquiry Manager optional features that the user wishes to utilize; “Enter”, which controls default characteristics of new inquiries that are entered; “Execute”, which controls default characteristics of security execution functions; “Disseminate”, which controls default characteristics of security dissemination functions; and “Reports” which allows custom reports to be specified. The “My Preferences” utility section also provides the user capability to archive Inquiry Manager data to alternate tables within the database to enhance application performance.

“Credits”—Selection of this menu item creates a display (not shown) that allows the user to maintain a list of approved and disapproved issuers of securities. This list is for informational purposes only and does not impact scenario algorithms for inquiry/security matching.

“Broker Dealers”—The broker/dealers utility creates a display (not shown) that allows the user to maintain a list of frequently used broker/dealers. Broker/dealers on this list appears on a pull-down list on the “Final Trade Execution” display shown in FIG. 9.

“Portfolio Managers”—This utility creates a display (not shown) that allows the user to maintain a list of portfolio managers. Broker/dealers on this list appears on a pull-down list on the “Inquiry Entry” pop-up display shown in FIG. 4.

“Trade Executions”—The “Trade Execution” utility creates a display (not shown) allowing the user to perform functions related to trades that have been executed in the Inquiry Manager database. Which trades are displayed is controlled through a filtering mechanism. In the event of entry error or trade problems, execution of a selected trade can be reversed, returning the inquiry and the security to their respective areas of the “Execution” display of FIG. 5. Execution reports for previously executed trades can also be displayed and printed. Trade data can also be exported in text format to memory 40 of computer 20 to allow integration with the Inquiry Manager users internal systems.

“System Settings”—The “System Settings” utility creates a display (not shown) that allows the user to maintain various system settings that control behavior of the Inquiry Manager application as well as diagnostic and repair functions.

Those skilled in the art will recognize that the preferred embodiments may be altered and modified without departing from the true spirit and scope of the invention as defined in the accompanying claims.

What is claimed is:

1. A method of organizing security inquiries and potential security purchases utilizing a computer with a display comprising:
entering into the computer inquiry information about securities desired for purchase;
entering into the computer potential purchase information about available securities;
entering into the computer a plurality of algorithms for matching the inquiry information with the purchase information;
selecting one of the algorithms;
matching by means of the selected one algorithm the inquiry information with the purchase information; and
reporting the results of the matching by means of the computer.

2. A method, as claimed in claim 1, wherein said inquiry information comprises a security par dollar amount for each of at least some of said securities desired for purchase, wherein said purchase information comprises a security dollar amount for each of at least some of said available securities and wherein said selected one algorithm attempts to match said security dollar amounts with said security par dollar amounts.

3. A method, as claimed in claim 2, wherein said selected one algorithm attempts to match each of said security dollar amounts in turn with said security par dollar amounts.

4. A method, as claimed in claim 1, wherein said inquiry information comprises a desired range of maturity times of at least some of said securities desired for purchase, wherein said purchase information comprises a maturity time for at least some of said available securities and wherein said selected one algorithm attempts to match said range of maturity times of said securities desired for purchase with said maturity time for said available securities.

5. A method, as claimed in claim 4, wherein said selected one algorithm attempts to match inquiry information with a smaller range of maturity times before attempting to match inquiry information with a larger range of maturity times.

6. A method, as claimed in claim 1, wherein said inquiry information is arranged in order and wherein said selected one algorithm matches attempts to match said purchase information with said inquiry information according to said order.

7. A method, as claimed in claim 6, wherein said order is the order in which said inquiry information was entered into said computer.

8. A method, as claimed in claim 1, wherein said entering inquiry information comprises entering a plurality of inquiries, each inquiry being limited to securities with a single issuer name.

9. A method, as claimed in claim 8, wherein said inquiries comprise an inquiry number, a state associated with said securities desired for purchase, and an account identifier.

10. A method, as claimed in claim 9, wherein said inquiries further comprise a quantity of said securities desired for purchase, a price of said securities desired for purchase and a range of maturity times for said securities desired for purchase.

11. A method, as claimed in claim 1, wherein said entering purchase information comprises entering a plurality entries about said available securities, at least some of said entries comprising a name of an issuer of the available security associated with the entry.

12. A method, as claimed in claim 11, wherein each said entry further comprises a state associated with the available security associated with the entry, the par dollar amount of the security associated with the entry, and the maturity time of the security associated with the entry.

13. A method, as claimed in claim 12, wherein said entry further comprises a CUSIP for said security associated with said entry.

14. A method, as claimed in claim 1, wherein said reporting comprises displaying said results on said computer display.

15. A method, as claimed in claim 1, and further comprising finalizing a trade of at least one of said available securities.

16. A method, as claimed in claim 15, wherein said finalizing comprises entering a CUSIP and a broker or dealer identification.

17. A method, as claimed in claim 15, wherein said finalizing comprises checking for similar or matching issues for previous security purchases for said inquiry information.

18. A method, as claimed in claim 15, wherein said reporting further comprises listing said available securities for which trade was finalized.

19. A method, as claimed in claim 15, wherein said reporting comprises listing said inquiry information not subject to said finalizing.

20. A method, as claimed in claim 1, wherein said available securities are issued by an issuer and wherein said reporting further comprises listing approved issuers.

21. A method, as claimed in claim 1, wherein said entering potential purchase information comprises:
entering potential purchase parameters;
searching a data base for security information corresponding to said parameters; and
reporting the results of said searching.

22. A method, as claimed in claim 21, wherein said database is located remotely from said computer and wherein said searching comprises transmitting data via the Internet.

23. A method, as claimed in claim 1, wherein said entering potential purchase information comprises:
selecting one of said available securities; and
reporting information about said selected security from a database.

24. A method, as claimed in claim 23, wherein said database is located remotely from said computer and wherein said reporting comprises transmitting data via the Internet.

25. A method, as claimed in claim 1, wherein said entering inquiry information comprises:
receiving said inquiry information from a data base; and
reporting said received inquiry information.

26. A method, as claimed in claim 25, wherein said database is located remotely from said computer and wherein said reporting comprises transmitting data via the Internet.

27. A method, as claimed in claim 1, wherein said entering potential purchase information comprises:
receiving said potential purchase information from a data base; and
reporting said received potential purchase information.

28. A method, as claimed in claim 27, wherein said database is located remotely from said computer and wherein said reporting comprises transmitting data via the Internet.

29. Apparatus for organizing security inquiries and potential security purchases comprising:
an output device arrange to display information;
a memory; and
a computer connected to:
store inquiry information about securities desired for purchase;
store potential purchase information about available securities;
store a plurality of algorithms for matching the inquiry information with the purchase information;
execute one of the algorithms;
match by means of the selected one algorithm the inquiry information with the purchase information; and
report the results of the matching on the output device.

30. Apparatus as claimed in claim 29, wherein said inquiry information comprises a security par dollar amount for each of at least some of said securities desired for purchase, wherein said purchase information comprises a security dollar amount for each of at least some of said available securities and wherein said selected one algorithm attempts to match said security dollar amounts with said security par dollar amounts.

31. Apparatus, as claimed in claim 30, wherein said selected one algorithm attempts to match each of said security dollar amounts in turn with said security par dollar amounts.

32. Apparatus, as claimed in claim 29, wherein said inquiry information comprises a desired range of maturity times of at least some of said securities desired for purchase, wherein said purchase information comprises a maturity time for at least some of said available securities and wherein said selected one algorithm attempts to match said range of maturity times of said securities desired for purchase with said maturity time for said available securities.

33. Apparatus, as claimed in claim 32, wherein said selected one algorithm attempts to match inquiry information with a smaller range of maturity times before attempting to match inquiry information with a larger range of maturity times.

34. Apparatus, as claimed in claim 29, wherein said inquiry information is arranged in order and wherein said selected one algorithm matches attempts to match said purchase information with said inquiry information according to said order.

35. Apparatus, as claimed in claim 34, wherein said order is the order in which said inquiry information was entered into said computer.

36. Apparatus, as claimed in claim 29, wherein said inquiry information comprises a plurality of inquiries, each inquiry being limited to securities with a single issuer name.

37. Apparatus, as claimed in claim 36, wherein said inquiries comprise an inquiry number, a state associated with said securities desired for purchase, and an account identifier.

38. Apparatus, as claimed in claim 37, wherein said inquiries further comprise a quantity of said securities desired for purchase, a price of said securities desired for purchase and a range of maturity times for said securities desired for purchase.

39. Apparatus, as claimed in claim 29, wherein said purchase information comprises a plurality entries about said available securities, at least some of said entries comprising a name of an issuer of the available security associated with the entry.

40. Apparatus, as claimed in claim 39, wherein each said entries further comprises a state associated with the available security associated with the entry, the par dollar amount of the security associated with the entry, and the maturity time of the security associated with the entry.

41. Apparatus, as claimed in claim 40, wherein each of said entries further comprises a CUSIP for said security associated with said entry.

42. Apparatus, as claimed in claim 29, wherein said output device comprises a computer display.

43. Apparatus, as claimed in claim 29, wherein said computer is further arranged to finalize a trade of at least one of said available securities.

44. Apparatus, as claimed in claim 43, wherein said computer finalizes the trade in part by storing a CUSIP and a broker or dealer identification.

45. Apparatus, as claimed in claim 43, wherein said computer finalizes the trade in part by checking for similar or matching issues for previous security purchases for said inquiry information.

46. Apparatus, as claimed in claim 43, wherein said computer is further arranged to list said available securities for which the trade was finalized.

47. Apparatus, as claimed in claim 43, wherein said computer is further arranged to list said inquiry information that was not finalized.

48. Apparatus, as claimed in claim 29, wherein said available securities are issued by an issuer and wherein said computer is arranged to list approved issuers.

49. Apparatus, as claimed in claim 29, and further comprising a second computer storing a database, wherein said potential purchase information comprises potential purchase parameters and wherein said computer searches the data base for security information corresponding to said parameters and reports the results of said searching on said output device.

50. Apparatus, as claimed in claim 49, wherein said database is second computer is located remotely from said computer and wherein said second computer transmits data to said computer via the Internet.

51. Apparatus, as claimed in claim 29, and further comprising a second computer storing a database, wherein said potential purchase information comprises one of said available securities and wherein said computer reports information about said selected security from said database.

52. Apparatus, as claimed in claim 51, wherein said second computer is located remotely from said computer and wherein said second computer transmits data to said computer via the Internet.

53. Apparatus, as claimed in claim 29, and further comprising a second computer storing a database, wherein said computer receives inquiry information from a data base and reports said inquiry information on said output device.

54. Apparatus, as claimed in claim 53, wherein said second computer is located remotely from said computer and wherein said second computer transmits data to said computer via the Internet.

55. Apparatus, as claimed in claim 29, and further comprising a second computer storing a database, wherein said computer receives said potential purchase information from said database and reports said received potential purchase information on said output device.

56. Apparatus, as claimed in claim 55, wherein said second computer is located remotely from said computer and wherein said second computer transmits data to said computer via the Internet.
